(19) United States
(12) Patent Application Publication
(10) Pub. No.: US 2022/0292345 A1
(43) Pub. Date: Sep. 15, 2022

(54) DISTRIBUTIONALLY ROBUST MODEL TRAINING

(71) Applicant: NEC CORPORATION, Tokyo (JP)

(72) Inventors: Vivek BARSOPIA, Tokyo (JP); Yoshio KAMEDA, Tokyo (JP); Tomoya SAKAI, Tokyo (JP)

(21) Appl. No.: 17/392,261

(22) Filed: Aug. 3, 2021

Related U.S. Application Data
(60) Provisional application No. 63/160,659, filed on Mar. 12, 2021.

(51) Int. Cl. G06N 3/08; G06N 3/04

(52) U.S. Cl. CPC G06N 3/08; G06N 3/0454

(57) ABSTRACT

Distributionally robust models are obtained by operations including training, according to a loss function, a first learning function with a training data set to produce a first model, the training data set including a plurality of samples. The operations may further include training a second learning function with the training data set to produce a second model, the second model having a higher accuracy than the first model. The operations may further include assigning an adversarial weight to each sample among the plurality of samples set based on a difference in loss between the first model and the second model. The operations may further include retraining, according to the loss function, the first learning function with the training data set to produce a distrtibutionally robust model, wherein during retraining the loss function further modifies loss associated with each sample among the plurality of samples based on the assigned adversarial weight.

### CROSS-REFERENCE TO RELATED APPLICATIONS

This application claims the benefit of U.S. Provisional Patent Application Ser. No. 63/160,659, filed on Mar. 12, 2021, which is hereby incorporated by reference in its entirety.

### BACKGROUND

In supervised machine learning, training is based on a training data set that has been curated by those familiar with the process. Although much effort can be spent making certain that training data sets are balanced representations of the distribution of data that is represented, latent sub-populations usually exist within the training data set. Such latent sub-populations may be over- or under-represented by the training data set, which results in unforeseen imbalances to the training data set. Such imbalances may not become apparent until inference, when live data being processed by a trained model undergoes shifts in sub-populations, causing a trained model to become much less accurate. Such occurrences can cause damage without warning, depending on the application of the trained model.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of data flow for distributionally robust model training, according to at least one embodiment of the present invention.

FIG. 2 is an operational flow for distributionally robust model training, according to at least one embodiment of the present invention.

FIG. 3 is an operational flow for assigning adversarial weights, according to at least one embodiment of the present invention.

FIG. 4 is an operational flow for retraining a learning function, according to at least one embodiment of the present invention.

FIG. 5 is a diagram of a data set having classes and sub-populations, according to at least one embodiment of the present invention.

FIG. 6 is a diagram of an interpretable model for classifying a data set having classes and sub-populations, according to at least one embodiment of the present invention.

FIG. 7 is a diagram of a complex model for classifying a data set having classes and sub-populations, according to at least one embodiment of the present invention.

FIG. 8 is a diagram of a hybrid model for classifying a data set having classes and sub-populations, according to at least one embodiment of the present invention.

FIG. 9 is a block diagram of an exemplary hardware configuration for distributionally robust model training, according to at least one embodiment of the present invention.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

In data classification, an algorithm is used to divide a data set into multiple classes. These classes may have multiple sub-populations or sub-categories that are not relevant to the immediate classification task. Some sub-populations or sub-categories are frequent and some are occasional. The relative frequencies of sub-populations can affect the performance of a classifier, which is an algorithm used to sort the data of the data set into the multiple classes. Some classifiers are trained using a concept known as Empirical Risk Minimization (ERM):

$$\hat{h} = arg {min}_{θ} \sum ℓ ( {h}_{θ} ( {x}_{i} ) , {y}_{i} ) , \qquad EQ . 1$$

where ĥ is the trained classifier algorithm, l is the loss function, h_{θ} is the classifier learning function, is the input to the classifier function, h_{θ}(xᵢ) represents the class output from the classifier function, and yᵢ is the true class.

To illustrate sub-populations by example, in a demand forecasting model to estimate daily sales, a classifier trained on a data set collected over the summer would perform very well on hotter days, due to the higher frequency of samples, but would not perform nearly as well on colder days, due to the lower frequency of samples. In this example, once the season changes from summer to winter, causing the number of colder days to significantly increase, the classifier would not perform well unless and until it is retrained on more samples collected from colder days.

A classifier that has stable performance despite shifts in sub-populations within data samples improves the lifespan and dependability of the classifier. In contrast, a classifier that degrades with sub-population shifts requires retraining, which has a significant cost in retraining and deployment.

Some stable classifiers are made with an understanding of sub-populations in the data set. By recognizing sub-populations, a classifier can be trained to perform well on each individual sub-population. The forecasting model example above is presented with an understanding of the sub-populations within the data set that caused a shift. However, because data sets have multiple sub-populations, some known and some unknown, it is often difficult to understand or predict which sub-populations will have a significant impact on classifier performance. To illustrate this using the foregoing example, if the sales being forecasted were of something weather-dependent, such as coats or sunscreen, then it is intuitive to think that the classifier must be trained on samples taken throughout the seasons. On the other hand, if the sales being forecasted were of batteries or milk, then it would not be intuitive to think that weather would have a significant impact on the classification. A classifier that can be trained to have stable performance despite shifts in sub-populations within data samples without an understanding of the sub-populations that cause shifts would perform well on even unknown sub-populations.

Some classifiers are trained to perform well on every data sample, or otherwise treat every data sample as a sub-population, such as by using the following adversarial weighting scheme:

$$\begin{matrix}{ω}_{i} ∝ ℓ ( {h}_{θ} ( {x}_{i} ) , {y}_{i} ) , & EQ . 2 \\ where & \\ ω ∈ W ; W = \{ ω \vert \sum f ( {ω}_{i} ) \leq \frac{δ}{N} , \sum {ω}_{i} = N , {ω}_{i} \geq 0 \} , & EQ . 3\end{matrix}$$

which assigns weight to loss, where, ω is an N-dimensional vector and its i^{th} element, denoted as ωᵢ, represents the assigned adversarial weight to i^{th} sample in the data set, N is the number of samples in the data set, and W is created by producing an f-diverge ball around the data set used for training. Classifiers using the adversarial weighting scheme in EQS. 2 and 3 are trained using the following loss function:

$$\hat{h} = arg {min}_{θ} {m ax}_{ω ∈ W} \sum {ω}_{i} * ℓ ( {h}_{θ} ( {x}_{i} ) , {y}_{i} ) . \qquad EQ . 4$$

By increasing the loss of samples misclassified during training, the classifier can be retrained with an emphasis on correctly classifying the previously misclassified samples. However, this includes treating noisy data samples as sub-populations, and treating noisy data samples as legitimate sub-populations reduces the performance of classifiers trained in this manner.

Some classifiers are machine learning algorithms designed with high dimensionality, and are trained to develop large and complex models for classification. Though such classifiers are often very accurate, training and inference of such classifiers require a large amount of computational resources, and the resulting models are often too complex for most of those having skill in the art to deem “interpretable,” meaning it is difficult to analyze, draw conclusions from, and ultimately learn from.

In at least some embodiments, classifiers that are designed to be easily interpreted and trained using a complex classifier result in interpretable models that are more robust and almost as accurate as interpretable classifiers trained to treat every sample as a sub-population, and are able to be inferred using less computational resources than the complex classifier. In at least some embodiments, such training methods assign adversarial weight based on a difference in loss between the interpretable classifier and the complex classifier. By assigning adversarial weight based on the difference in loss between the interpretable classifier and the complex classifier, loss is increased only for samples that were incorrectly classified by the interpretably classifier function, yet correctly classified by the complex classifier function. The samples that are misclassified by the complex classifier function are excluded from loss increase and treated as noisy samples. By increasing the loss of only samples that are both misclassified by the interpretable classifier function and correctly classified by the complex classifier function, the interpretable classifier function can be retrained with an emphasis on correctly classifying only the previously misclassified samples that are not noisy samples to produce a distributionally robust classifier.

In at least some embodiments, the accuracy of the distributionally robust classifier increases as the design of the complex classifier is tuned to compliment the interpretable classifier. However, a complex classifier that is complex enough to perform perfectly on a training data set will not improve a classifier any more than a classifier trained using an adversarial weighting scheme that treats every data sample as a sub-population, because the training will effectively treat noisy data samples as sub-populations. In at least some embodiments, a higher robustness of a hybrid classifier will remain accurate across a broader spectrum of circumstances, and will be usable for longer periods of time. In at least some embodiments, training a distributionally robust classifier can be executed using the same Application Programming Interface (API) as any other training procedure.

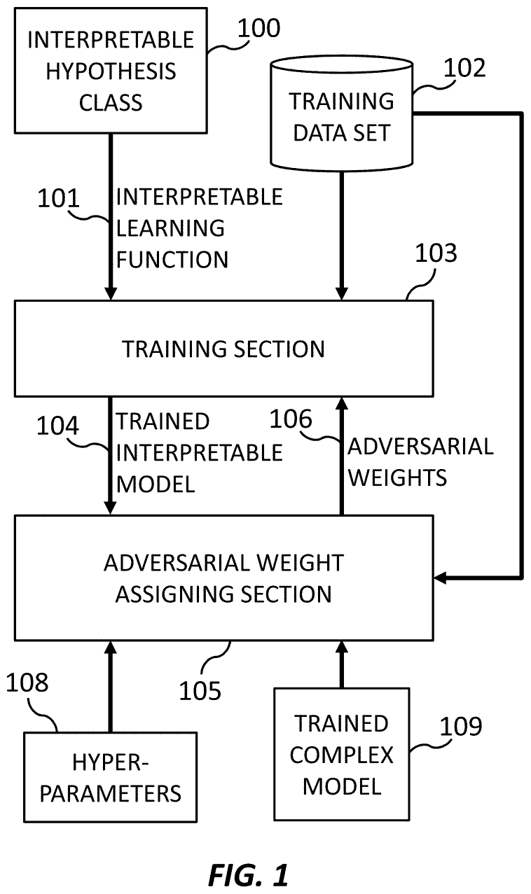

FIG. 1 is a schematic diagram of data flow for distributionally robust model training, according to at least one embodiment of the present invention. The diagram includes interpretable hypothesis class 100, training section 101, training data set 102, trained interpretable model 103, adversarial weight assigning section 105, adversarial weights 106, hyper-parameters 108, and trained complex model 109.

Interpretable hypothesis class 100 is a class or group of learning functions that have been deemed to be “interpretable”, at least for a given task. There is no mathematical definition of “interpretability”, but basically a learning function and resulting model are interpretable if the connections the model makes between input and output are within human comprehension. In other words, if a human can understand the underlying rationale for the decisions that the model makes, then the model is deemed to be interpretable. Although “interpretability” is considered by some to be both subjective and application ambiguous, there is generally agreement among those having skill in the art that “interpretability” varies inversely with “accuracy”. In other words, when increasing the “interpretability” of a model, there is likely to be a sacrifice in “accuracy” Likewise, when increasing the “accuracy” of a model, there is likely to be a sacrifice in “interpretability.” In at least some embodiments, interpretable hypothesis class 100 includes learning functions of Empirical Risk Minimization (ERM). In at least some embodiments, interpretable hypothesis class 100 includes Hierarchical Mixtures of Experts (HME) suitable for Factorized Asymptotic Bayesian (FAB) inference.

Interpretable learning function 101 is one of a plurality of interpretable learning functions comprising interpretable hypothesis class 100. In at least some embodiments, interpretable learning function 101 is a neural network or other type of machine learning algorithm or approximate function. In at least some embodiments, interpretable learning function 101 includes weights having randomly assigned values between zero and one.

Training data set 102 is a data set including a plurality of samples. Each sample has a label indicating the correct result. In other words, when the sample is input into a model, the model should output the correct result indicated in the corresponding label. In at least some embodiments, training data set 102 is prepared and curated so that it is representative of an actual distribution. However, as explained above, it is difficult to identify all significant sub-populations within an actual distribution, it is likely that training data set 102 does not adequately represent at least one sub-population of the actual distribution.

Training section 103 is configured to train interpretable learning function 101 based on training data set 102 to produce trained interpretable model 104. In at least some embodiments, training section 103 is configured to apply interpretable learning function 101 to training data 102, and to make adjustments to weights of interpretable learning function 101 based on the output of interpretable learning function 101 in response to input of training data 102. In at least some embodiments, training section 103 is configured to make adjustments to weights of interpretable learning function 101 further based on adversarial weights 106. In at least some embodiments, training section 103 is configured to perform multiple epochs of training to produce trained interpretable model 104 as a classification model or a regression model. In at least some embodiments, training section 103 is configured to perform training to produce multiple iterations of trained interpretable model 104, each iteration of trained interpretable model 104 trained on a different set of adversarial weights. In at least some embodiments, training section 103 is configured to train a complex learning function to produce trained complex model 109.

Adversarial weight assigning section 105 is configured to assign adversarial weights to training data set 102 based on trained interpretable model 104, hyper-parameters 108, and trained complex model 109. In at least some embodiments, adversarial weight assigning section 105 assign a weight to a sample of training data 102 based on a difference in output between trained interpretable model 104 and trained complex model 109. In at least some embodiments, adversarial weight assigning section 104 is configured to assign an even distribution of weights to training data 102 until training section 103 produces a first iteration of trained interpretable model 104.

Hyper-parameters 108 include values that affect the assignment of adversarial weights by adversarial weight assigning section 105. In at least some embodiments, hyper-parameters 108 include a hyper-parameter that affects the width of the distribution of adversarial weights. In at least some embodiments, hyper-parameters 108 include a learning coefficient.

Trained complex model 109 is trained from a neural network or other type of machine learning algorithm or approximate function that is, in at least some embodiments, more complex but less interpretable than interpretable learning function 101. In at least some embodiments, trained complex model 109 includes weights that have been adjusted through training based on training data set 102 to become an accurate model. In at least some embodiments, compared to trained interpretable model 104, trained complex model 109 is more accurate on training data 102. In at least some embodiments, compared to interpretable learning function 101, the learning function from which trained complex model 109 has been trained has a higher Vapnik-Chervonenkis (VC) dimension, higher parameter count, higher Minimum Description Length, or any other complexity measurement metric.

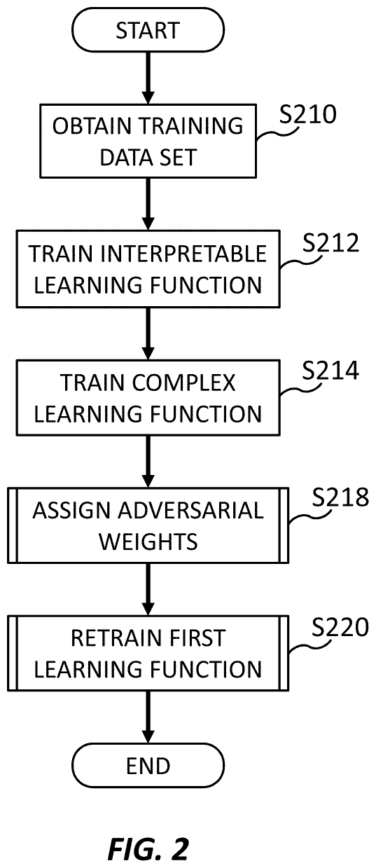

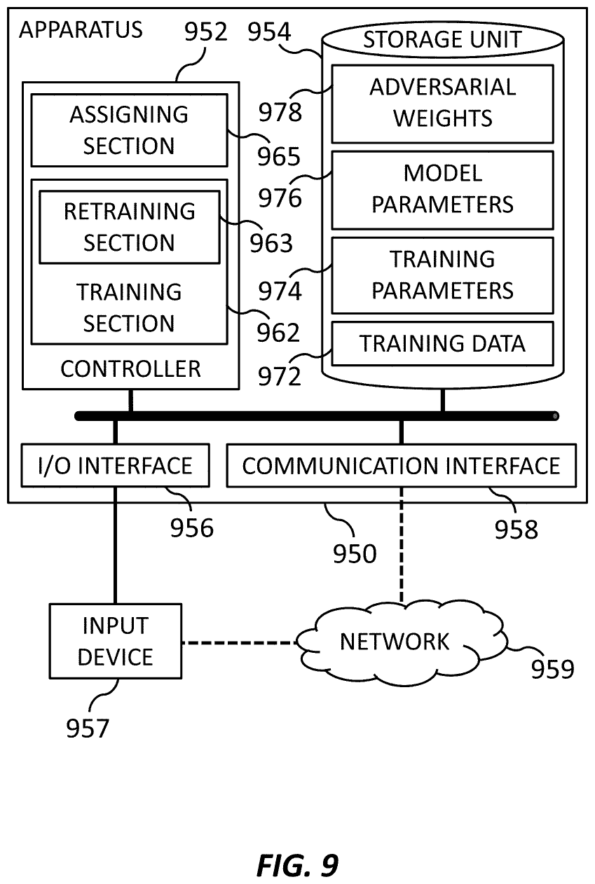

FIG. 2 is an operational flow for distributionally robust model training, according to at least one embodiment of the present invention. The operational flow provides a method of distributionally robust model training. In at least some embodiments, the method is performed by an apparatus including sections for performing certain operations, such as the apparatus shown in FIG. 9, which will be explained hereinafter.

At S210, an obtaining section obtains a training data set, such as training data set 102 in FIG. 1. In at least some embodiments, the obtaining section retrieves the training data set from a device through a network. In at least some embodiments, the obtaining section stores the training data set on a computer-readable medium of the apparatus.

At S212, a training section, such as training section 103 in FIG. 1, or a sub-section thereof trains an interpretable learning function based on the training data set obtained at S210. In at least some embodiments, the training section trains the interpretable learning function to produce an interpretable model for classification or regression. In at least some embodiments, the training section trains the interpretable learning function by minimizing the loss function:

$$\hat{h} = arg {min}_{θ} \sum {ω}_{i} * ℓ ( {h}_{θ} ( {x}_{i} ) , {y}_{i} ) , \qquad EQ . 5$$

where ĥ is the interpretable model, and the adversarial weights ωᵢ are uniform. In at least some embodiments, at S212 the training section trains, according to a loss function, a first learning function with the training data set to produce a first model, the training data set including a plurality of samples.

At S214, the training section or a sub-section thereof trains a complex learning function based on the training data set obtained at S210. In at least some embodiments, the complex learning function is trained to produce a complex model for classification or regression. In at least some embodiments, the operation at S214 is performed by a different training section than the operation at S212. In at least some embodiments, at S214 the training section trains a second learning function with the training data set to produce a second model, the second model having a higher accuracy than the first model. In at least some embodiments, the first model has a higher interpretability than the second model. In at least some embodiments, the first learning function has a lower Vapnik-Chervonenkis (VC) dimension or other complexity measurement metric than the second learning function. In at least some embodiments, the first learning function and the second learning function are classification functions. In at least some embodiments, the first learning function and the second learning function are regression functions.

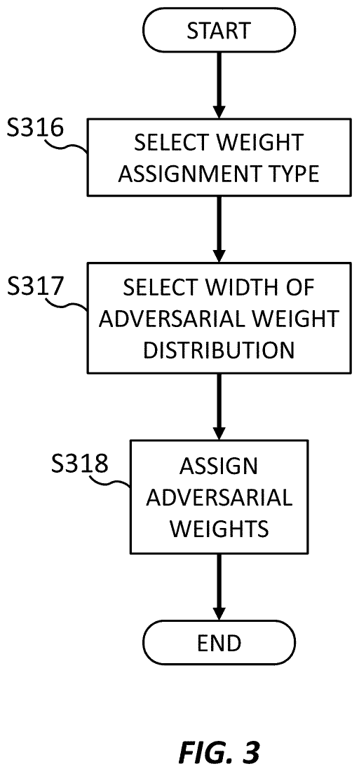

At S218, an assigning section assigns adversarial weights to the training data set obtained at S210. In at least some embodiments, the assigning section assigns the adversarial weights based on a difference in output between the interpretable model and the complex model. In at least some embodiments, the assigning section assigns an adversarial weight to each sample among the plurality of samples of the training data set based on a difference in loss between the interpretable model and the complex model. Further details of at least some embodiments of the adversarial weight assignment are described with respect to FIG. 3. In at least some embodiments, at S218 the assigning section assigns an adversarial weight to each sample among the plurality of samples of the training data set based on a difference in loss between the first model and the second model.

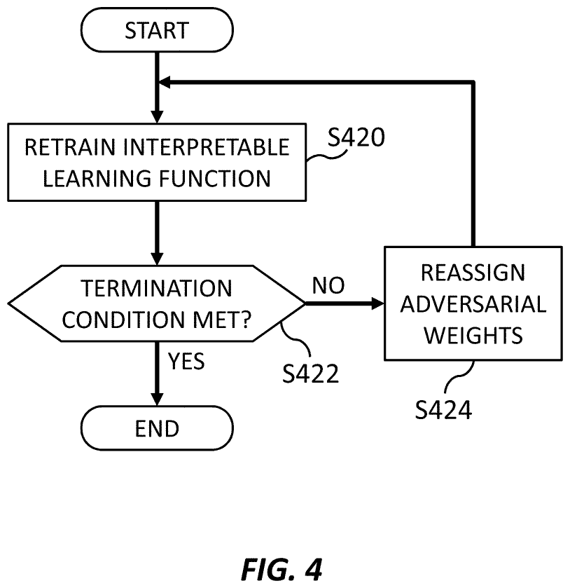

At S220, a retraining section retrains the interpretable learning function based on the assigned adversarial weights. In at least some embodiments, the retraining section begins the operation at S220 by resetting the weights of the interpretable learning function to randomly assigned values between zero and one. In at least some embodiments, the operation at S220 is performed by a sub-section of the training section. In at least some embodiments, the retraining section retrains, according to the loss function, the interpretable learning function with the training data set to produce a distributionally robust model, wherein during retraining the loss function further modifies loss associated with each sample among the plurality of samples based on the assigned adversarial weight. Further details of at least some embodiments of the adversarial weight assignment are described with respect to FIG. 3. In at least some embodiments, at S220 the retraining section retrains, according to the loss function, the first learning function with the training data set to produce a distributionally robust model, wherein during retraining the loss function further modifies loss associated with each sample among the plurality of samples based on the assigned adversarial weight. In at least some embodiments, the retraining includes a plurality of retraining iterations, each retraining iteration including a reassigning of adversarial weights. Further details of at least some embodiments of the retraining iterations are described with respect to FIG. 4.

FIG. 3 is an operational flow for assigning adversarial weights, according to at least one embodiment of the present invention. The operational flow provides a method of assigning adversarial weights. In at least some embodiments, the method is performed by an assigning section, such as adversarial weight assigning section 105 in FIG. 1, or correspondingly named sub-sections thereof.

At S316, the assigning section or a sub-section thereof selects a type of adversarial weight assignment. In at least some embodiments, the assigning section selects one type of adversarial weight assignment among loss calculation, sample value, and number of samples. In at least some embodiments, the assigning section assigns weights to be applied directly to the loss calculation, so that the loss of each sample is multiplied directly by an adversarial weight value. In at least some embodiments, the assigning section assigns weights to be applied indirectly to the loss calculation. In at least some embodiments, the assigning section assigns weights to be applied to the sample value, so that the value of each sample is adjusted by an adversarial weight value, and thus having an indirect impact on the loss calculation. In at least some embodiments, the assigning section assigns weights to be applied to the number of samples, so that each sample is repeated, within the training data set, a number of times in proportion to an adversarial weight value, and thus having an indirect impact on the loss calculation. In at least some embodiments, the assigning section receives a selection of adversarial weight assignment.

At S317, the assigning section or a sub-section thereof selects a width of adversarial weight distribution. In at least some embodiments, the assigning includes selecting a width of adversarial weight distribution. In at least some embodiments, the assigning section selects a value for hyper-parameter b such that:

ω∈[b, ∞]^{N}; Σωᵢ=N EQ. 6.

In at least some embodiments, a lower value of b results in a wider weight distribution. In at least some embodiments, a higher value of b results in a narrower weight distribution. In at least some embodiments, compared to using lower values of b, using higher values of b leads to higher accuracy and lower robustness. In at least some embodiments, using smaller values of b increases a likelihood that the loss function will not converge on a solution.

At S318, an assigning section assigns adversarial weights to the training data set. In at least some embodiments, the assigning section assigns the adversarial weights based on a difference in output between the interpretable model and the complex model. In at least some embodiments, the assigning section assigns an adversarial weight to each sample of the training data set based on a difference in loss between the interpretable model and the complex model. In at least some embodiments, the assigning section is configured to use the following adversarial weighting scheme:

ωᵢ∝l(h_{θ}(xᵢ), yᵢ)−l(M(xᵢ), yᵢ) EQ. 7,

where h_{θ} is the interpretable classifier function, and M is the complex classifier function. In at least some embodiments, the assigning section assigns an adversarial weight based further on the value of b.

FIG. 4 is an operational flow for retraining a learning function, according to at least one embodiment of the present invention. The operational flow provides a method of retraining a learning function. In at least some embodiments, the method is performed by a retraining section, such as training section 104 in FIG. 1, or correspondingly named sub-sections thereof.

At S420, the retraining section or a sub-section thereof retrains the interpretable learning function based on the assigned adversarial weights. In at least some embodiments, the retraining section begins the operation at S420 by resetting the weights of the interpretable learning function to randomly assigned values between zero and one. In at least some embodiments, the retraining section retrains the first learning function with the training data set to produce a hybrid model, wherein loss is increased based on the assigned adversarial weight. In at least some embodiments, the retraining section retrains the model by minimizing the loss function, as modified by the adversarial weights:

$$\hat{h} , \hat{ω} = arg {min}_{θ} {m ax}_{ω ∈ {[ b , ∞ ]}^{N}} \sum {ω}_{i} * ( ℓ ( {h}_{θ} ( {x}_{i} ) , {y}_{i} ) - ℓ ( M ( {x}_{i} ) , {y}_{i} ) ) , \qquad EQ . 8$$

where ĥ is the interpretable model, \hat{ω} the adversarial weight distribution including individual adversarial weights ωᵢ according to the latest assignment, and M is the complex model. In at least some embodiments the retraining section performs retraining for one or more epochs. In at least some embodiments the retraining section performs retraining until the loss function has converged on a minimum.

At S422, the retraining section or a sub-section thereof determines whether a termination condition has been met. If the termination condition has not been met, then the operational flow proceeds to S424 for adversarial weight reassignment before another iteration of retraining at S420. In at least some embodiments, the termination condition is met after a designated number of iterations of retraining at S420 have been performed. In at least some embodiments, the designated number of iterations of retraining at S420 is in a range of 6-10 iterations, inclusively.

At S424, the retraining section or a sub-section thereof reassigns adversarial weights to the training data set. In at least some embodiments, the retraining section causes an assigning section, such as adversarial weight assigning section 105 in FIG. 1, to reassign adversarial weights. In at least some embodiments, the reassigning is based on a difference in loss between the first model as trained in the immediately preceding iteration of the retraining and the second model. In at least some embodiments, the retraining section performs adversarial weight reassignment at S424 in the same manner as S318 in FIG. 3, except using the interpretable model as trained by the latest iteration. In at least some embodiments, the reassigning is further based on the adversarial weight of one or more preceding iterations of the retraining. In at least some embodiments, the retraining section further modifies the adversarial weight assignment using the adversarial weight assignment of previous iterations.

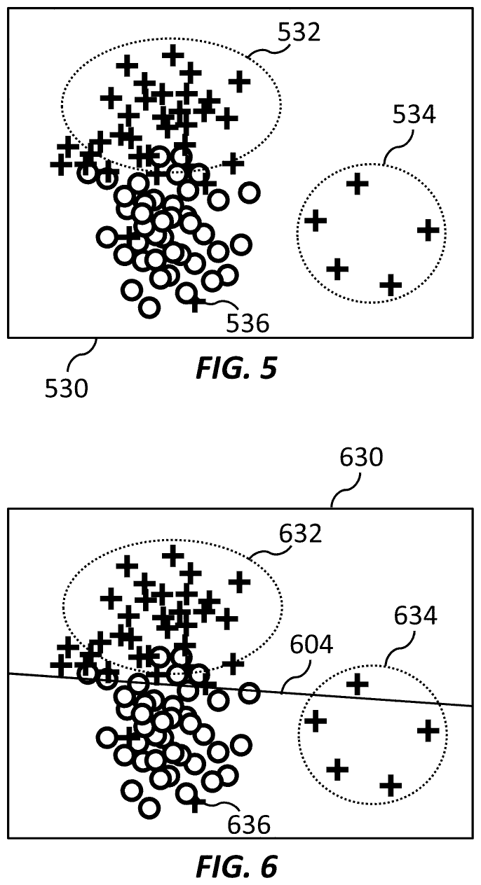

FIG. 5 is a diagram of a data set 530 having classes and sub-populations, according to at least one embodiment of the present invention. Data set 530 may be used as a training data set, such as training data set 102 in FIG. 1, for training a learning function to produce a classification model. Data set 530 includes a plurality of samples. Each sample is characterized by x and y coordinates, and is paired with a label that reflects the class to which it belongs. The classes include a first class, denoted in FIG. 5 by +, and a second class, denoted in FIG. 5 by o. FIG. 5 shows each sample as the corresponding label and plotted at a position consistent with the x and y coordinates of the sample's characterization.

The first class of data set 530 has two visible sub-populations, shown as sub-population 532, and sub-population 534. Sub-population 532 has many samples, but sub-population 534 has only 5 samples. It should be understood that sub-population 532 and sub-population 534 are not represented in the information provided in data set 530. Instead, sub-population 532 and sub-population 534 may have some commonality in the underlying data that makes up data set 530, or from which data set 530 was formed, but such commonality is not actually represented in the information provided in the data set. As such, sub-population 534 may not have any commonality, and may exist purely by coincidence. On the other hand, sub-population 534 may underrepresent an actual commonality. In at least some embodiments of the method of FIGS. 2-4, it is not necessary to be certain whether sub-population 534, or any other sub-population of data set 530, actually has commonality.

The first class of data set 530 has a noisy sample 536. Noisy sample 536 is labeled in the first class, but is surrounded by nothing but samples from the second class. Noisy sample 536 is considered to be a noisy sample not because it is believed to be incorrectly labeled, but rather because it will not help in the process of producing a classification model. In other words, even if a classification model was trained to correctly label sample 536, such classification model would likely be considered “overfit”, and thus not accurate for classifying data other than in data set 530.

FIG. 6 is a diagram of an interpretable model 604 for classifying a data set 630 having classes and sub-populations, according to at least one embodiment of the present invention. Data set 630 includes sub-population 632, sub-population 634, and noisy sample 636, which correspond to sub-population 532, sub-population 534, and noisy sample 536 in FIG. 5, respectively, and thus should be understood to have the same qualities unless explicitly described otherwise.

Interpretable model 604 is shown plotted against data set 630 to illustrate the decision boundary that interpretable model 604 uses to determine the classification of samples in data set 630. Interpretable model 604 has a linear decision boundary, which is likely to be easily understood, and thus interpretable, that determines classification based on which side of the decision boundary the sample falls. In at least some embodiments, interpretable model 604 is representative of the result of training an interpretable learning function without adversarial weight assignment, such as in the operation at S212 of FIG. 2.

Some of the samples are located on the side of the decision boundary of interpretable model 604 populated mostly by samples of the other class. These are the samples that are being misclassified by interpretable model 604. In particular, several samples within sub-population 634 and noisy sample 636 are located below the decision boundary of interpretable model 604, and are thus misclassified. The amount of samples that are misclassified corresponds to the accuracy of interpretable model 604.

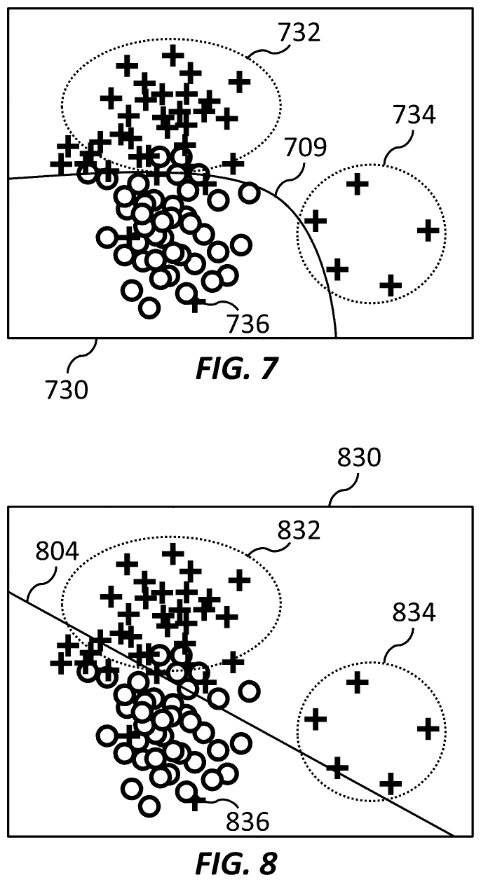

FIG. 7 is a diagram of a complex model 709 for classifying a data set 730 having classes and sub-populations, according to at least one embodiment of the present invention. Data set 730 includes sub-population 732, sub-population 734, and noisy sample 736, which correspond to sub-population 532, sub-population 534, and noisy sample 536 in FIG. 5, respectively, and thus should be understood to have the same qualities unless explicitly described otherwise.

Complex model 709 is shown plotted against data set 730 to illustrate the decision boundary complex model 709 uses to determine the classification of samples in data set 70. Complex model 709 has a non-linear decision boundary, which is less interpretable than a linear decision boundary, and therefore less interpretable than interpretable model 604 in FIG. 6, that determines classification based on which side of the decision boundary the sample falls. Whether or not complex model 709 is likely to be understood or not is subjective, but a non-linear decision boundary is less likely to be understood by a given person than a linear decision boundary. In at least some embodiments, complex model 709 is representative of the result of training a complex learning function, such as in the operation at S214 of FIG. 2.

Some of the samples are located on the side of the decision boundary of complex model 709 populated mostly by samples of the other class. These are the samples that are being misclassified by complex model 709. Compared to interpretable model 604 in FIG. 6, less samples are being misclassified by complex model 709. In particular, all samples within sub-population 734 are located on the correct side of the decision boundary of interpretable model 704, and are thus correctly classified. Though noisy sample 736 is misclassified, misclassification of noisy samples is generally considered to be better than correctly classifying noisy samples, because correct classification of noisy samples is an indication of an “overfit” model. Because the amount of samples that are misclassified corresponds to the accuracy, complex model 709 is more accurate than interpretable model 604 in FIG. 6.

FIG. 8 is a diagram of a distributionally robust model 804 for classifying a data set 830 having classes and sub-populations, according to at least one embodiment of the present invention. Data set 830 includes sub-population 832, sub-population 834, and noisy sample 836, which correspond to sub-population 532, sub-population 534, and noisy sample 536 in FIG. 5, respectively, and thus should be understood to have the same qualities unless explicitly described otherwise.

Distributionally robust model 804 is shown plotted against data set 830 to illustrate the decision boundary distributionally robust model 804 uses to determine the classification of samples in data set 830. Distributionally robust model 804 has a linear decision boundary, which is likely to be easily understood, and thus interpretable, that determines classification based on which side of the decision boundary the sample falls. In at least some embodiments, distributionally robust model 804 is representative of the result of retraining an interpretable learning function based on adversarial weight assignment, such as in the operation at S220 of FIG. 2.

Some of the samples are located on the side of the decision boundary of distributionally robust model 804 populated mostly by samples of the other class. These are the samples that are being misclassified by distributionally robust model 804. Compared to interpretable model 604 in FIG. 6, more samples are being misclassified by distributionally robust model 804. However, unlike interpretable model 604, all samples within sub-population 834 are located on the correct side of the decision boundary of distributionally robust model 804, and are thus correctly classified. Though noisy sample 836 is misclassified, misclassification of noisy samples is generally considered to be better than correctly classifying noisy samples, because correct classification of noisy samples is an indication of an “overfit” model.

Because the amount of samples that are misclassified corresponds to the accuracy, distributionally robust model 804 is less accurate than interpretable model 604 in FIG. 6, and thus also less accurate than complex model 709. However, because all samples within sub-population 834 are located on the correct side of the decision boundary of distributionally robust model 804, distributionally robust model 804 is more robust than interpretable model 604, meaning that distributionally robust model 804 is more likely to maintain a steady accuracy in the event of a shift in sub-populations. In other words, if the source of data set 830, which is the same as data set 630, were to shift such that sub-population 834 included many more data points, then distributionally robust model 804 would likely become more accurate than interpretable model 604, because interpretable model 604 correctly classifies only 20% of the samples of sub-population 634 within data set 630 while distributionally robust model 804 correctly classifies 100% of the samples of sub-population 834 within data set 830.

FIG. 9 is a block diagram of an exemplary hardware configuration for distributionally robust model training, according to at least one embodiment of the present invention. The exemplary hardware configuration includes apparatus 950, which communicates with network 942, and interacts with input device 957. Apparatus 950 may be a computer or other computing device that receives input or commands from input device 957. Apparatus 950 may be a host server that connects directly to input device 957, or indirectly through network 959. In some embodiments, apparatus 950 is a computer system that includes two or more computers. In some embodiments, apparatus 950 is a personal computer that executes an application for a user of apparatus 950.

Apparatus 950 includes a controller 952, a storage unit 954, a communication interface 958, and an input/output interface 956. In some embodiments, controller 952 includes a processor or programmable circuitry executing instructions to cause the processor or programmable circuitry to perform operations according to the instructions. In some embodiments, controller 952 includes analog or digital programmable circuitry, or any combination thereof. In some embodiments, controller 952 includes physically separated storage or circuitry that interacts through communication. In some embodiments, storage unit 954 includes a non-volatile computer-readable medium capable of storing executable and non-executable data for access by controller 952 during execution of the instructions. Communication interface 958 transmits and receives data from network 959. Input/output interface 956 connects to various input and output units via a parallel port, a serial port, a keyboard port, a mouse port, a monitor port, and the like to accept commands and present information.

Controller 952 includes training section 962, which includes retraining section 963, and assigning section 965. Storage unit 954 includes training data 972, training parameters 974, and model parameters 976.

Training section 962 is the circuitry or instructions of controller 952 configured to train learning functions. In at least some embodiments, training section 962 is configured to train interpretable learning functions, such as interpretable learning function 101 in FIG. 1, to produce interpretable models, such as trained interpretable model 104 in FIG. 1, complex learning functions to produce complex models, such as trained complex model 109 in FIG. 1, etc. In at least some embodiments, training section 962 utilizes information in storage unit 954, such as training data 972, loss functions and hyper-parameters included in training parameters 974, and learning functions and trained models included in model parameters 976. In at least some embodiments, training section 962 includes sub-sections for performing additional functions, as described in the foregoing flow charts. Such sub-sections may be referred to by a name associated with their function, such as retraining section 963.

Retraining section 963 is the circuitry or instructions of controller 952 configured to retrain learning functions based on adversarial weight assignments. In at least some embodiments, retraining section 963 is configured to retrain interpretable learning functions, such as interpretable learning function 101 in FIG. 1, to produce interpretable models, such as trained interpretable model 104 in FIG. 1, etc. In at least some embodiments, retraining section 963 utilizes information in storage unit 954, such as training data 972, loss functions and hyper-parameters included in training parameters 974, learning functions and trained models included in model parameters 976, and adversarial weights 978. In at least some embodiments, retraining section 963 includes sub-sections for performing additional functions, as described in the foregoing flow charts. Such sub-sections may be referred to by a name associated with their function.

Assigning section 965 is the circuitry or instructions of controller 952 configured to assign adversarial weights. In at least some embodiments, assigning section 965 is configured to assign adversarial weights to training data 972 based on a trained interpretable model and a complex model included in model parameters 976 and hyper-parameters included in training parameters 974. In at least some embodiments, assigning section 965 records values in adversarial weights 978. In some embodiments, assigning section 965 includes sub-sections for performing additional functions, as described in the foregoing flow charts. In some embodiments, such sub-sections are referred to by a name associated with the corresponding function.

In at least some embodiments, the apparatus is another device capable of processing logical functions in order to perform the operations herein. In at least some embodiments, the controller and the storage unit need not be entirely separate devices, but share circuitry or one or more computer-readable mediums in some embodiments. In at least some embodiments, the storage unit includes a hard drive storing both the computer-executable instructions and the data accessed by the controller, and the controller includes a combination of a central processing unit (CPU) and RAM, in which the computer-executable instructions are able to be copied in whole or in part for execution by the CPU during performance of the operations herein.

In at least some embodiments where the apparatus is a computer, a program that is installed in the computer is capable of causing the computer to function as or perform operations associated with apparatuses of the embodiments described herein. In at least some embodiments, such a program is executable by a processor to cause the computer to perform certain operations associated with some or all of the blocks of flowcharts and block diagrams described herein.

Various embodiments of the present invention are described with reference to flowcharts and block diagrams whose blocks may represent (1) steps of processes in which operations are performed or (2) sections of a controller responsible for performing operations. Certain steps and sections are implemented by dedicated circuitry, programmable circuitry supplied with computer-readable instructions stored on computer-readable media, and/or processors supplied with computer-readable instructions stored on computer-readable media. In some embodiments, dedicated circuitry includes digital and/or analog hardware circuits and may include integrated circuits (IC) and/or discrete circuits. In some embodiments, programmable circuitry includes reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

Various embodiments of the present invention include a system, a method, and/or a computer program product. In some embodiments, the computer program product includes a computer readable storage medium (or media) having computer readable program instructions thereon for causing a processor to carry out aspects of the present invention.

In some embodiments, the computer readable storage medium includes a tangible device that is able to retain and store instructions for use by an instruction execution device. In some embodiments, the computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, computer readable program instructions described herein are downloadable to respective computing/processing devices from a computer readable storage medium or to an external computer or external storage device via a network, for example, the Internet, a local area network, a wide area network and/or a wireless network. In some embodiments, the network may includes copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

In some embodiments, computer readable program instructions for carrying out operations described above are assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In some embodiments, the computer readable program instructions are executed entirely on the user's computer, partly on the user's computer, as a stand-alone software package, partly on the user's computer and partly on a remote computer or entirely on the remote computer or server. In some embodiments, in the latter scenario, the remote computer is connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) execute the computer readable program instructions by utilizing state information of the computer readable program instructions to individualize the electronic circuitry, in order to perform aspects of the present invention.

While embodiments of the present invention have been described, the technical scope of any subject matter claimed is not limited to the above described embodiments. It will be apparent to persons skilled in the art that various alterations and improvements can be added to the above-described embodiments. It will also be apparent from the scope of the claims that the embodiments added with such alterations or improvements are included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the processes must be performed in this order.

According to at least one embodiment of the present invention, distributionally robust models are obtained by operations including training, according to a loss function, a first learning function with a training data set to produce a first model, the training data set including a plurality of samples. The operations may further include training a second learning function with the training data set to produce a second model, the second model having a higher accuracy than the first model. The operations may further include assigning an adversarial weight to each sample among the plurality of samples set based on a difference in loss between the first model and the second model. The operations may further include retraining, according to the loss function, the first learning function with the training data set to produce a distributionally robust model, wherein during retraining the loss function further modifies loss associated with each sample among the plurality of samples based on the assigned adversarial weight.

Some embodiments include the instructions in a computer program, the method performed by the processor executing the instructions of the computer program, and an apparatus that performs the method. In some embodiments, the apparatus includes a controller including circuitry configured to perform the operations in the instructions.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A computer-readable medium including instructions executable by a computer to cause the computer to perform operations comprising:
training, according to a loss function, a first learning function with a training data set to produce a first model, the training data set including a plurality of samples;
training a second learning function with the training data set to produce a second model, the second model having a higher accuracy than the first model;
assigning an adversarial weight to each sample among the plurality of samples based on a difference in loss between the first model and the second model; and
retraining, according to the loss function, the first learning function with the training data set to produce a distributionally robust model, wherein during retraining the loss function further modifies loss associated with each sample among the plurality of samples based on the assigned adversarial weight.

2. The computer-readable medium of claim 1, wherein the first model has a higher interpretability than the second model.

3. The computer-readable medium of claim 1, wherein the first learning function has a lower Vapnik-Chervonenkis (VC) dimension, lower parameter count, or lower Minimum Description Length than the second learning function.

4. The computer-readable medium of claim 1, wherein
the retraining includes a plurality of retraining iterations, each retraining iteration among the plurality of retraining iterations including a reassigning of adversarial weights, and
the reassigning is based on a difference in loss between the first model as trained in an immediately preceding retraining iteration among the plurality of retraining iterations of the retraining and the second model.

5. The computer-readable medium of claim 4, wherein the reassigning is further based on the adversarial weight of one or more preceding retraining iterations among the plurality of retraining iterations of the retraining.

6. The computer-readable medium of claim 1, wherein the assigning includes selecting a width of adversarial weight distribution.

7. The computer-readable medium of claim 1, wherein the first learning function and the second learning function are classification functions.

8. The computer-readable medium of claim 1, wherein the first learning function and the second learning function are regression functions.

9. A method comprising:
training, according to a loss function, a first learning function with a training data set to produce a first model, the training data set including a plurality of samples;
training a second learning function with the training data set to produce a second model, the second model having a higher accuracy than the first model;
assigning an adversarial weight to each sample among the plurality of samples based on a difference in loss between the first model and the second model; and
retraining, according to the loss function, the first learning function with the training data set to produce a distributionally robust model, wherein during retraining the loss function further modifies loss associated with each sample among the plurality of samples based on the assigned adversarial weight.

10. The method of claim 9, wherein the first model has a higher interpretability than the second model.

11. The method of claim 9, wherein the first learning function has a lower Vapnik-Chervonenkis (VC) dimension, lower parameter count, or lower Minimum Description Length than the second learning function.

12. The method of claim 9, wherein
the retraining includes a plurality of retraining iterations, each retraining iteration among the plurality of retraining iterations including a reassigning of adversarial weights, and
the reassigning is based on a difference in loss between the first model as trained in an immediately preceding retraining iteration among the plurality of retraining iterations of the retraining and the second model.

13. The method of claim 12, wherein the reassigning is further based on the adversarial weight of one or more preceding retraining iterations among the plurality of retraining iterations.

14. The method of claim 9, wherein the assigning includes selecting a width of adversarial weight distribution.

15. The method of claim 9, wherein the first learning function and the second learning function are classification functions.

16. The method of claim 9, wherein the first learning function and the second learning function are regression functions.

17. An apparatus comprising:
a controller including circuitry configured to
train, according to a loss function, a first learning function with a training data set to produce a first model, the training data set including a plurality of samples;
train a second learning function with the training data set to produce a second model, the second model having a higher accuracy than the first model;
assign an adversarial weight to each sample among the plurality of samples based on a difference in loss between the first model and the second model; and
retrain, according to the loss function, the first learning function with the training data set to produce a distributionally robust model, wherein during retraining the loss function further modifies loss associated with each sample among the plurality of samples based on the assigned adversarial weight.

18. The apparatus of claim 17, wherein the first model has a higher interpretability than the second model.

19. The apparatus of claim 17, wherein the first learning function has a lower Vapnik-Chervonenkis (VC) dimension, lower parameter count, or lower Minimum Description Length than the second learning function.

20. The apparatus of claim 17, wherein
the controller is further configured to reassign adversarial weights in each retraining iteration among a plurality of retraining iterations to retrain the first learning function, and
the reassigned adversarial weights are based on a difference in loss between the first model as trained in an immediately preceding retraining iteration among the plurality of retraining iterations and the second model.
